(19) United States
(12) Patent Application Publication
(10) Pub. No.: US 2010/0313112 A1
(43) Pub. Date: Dec. 9, 2010

(54) Method And System For Indicating A Form Mapping

(75) Inventor: Dick C. Hardt, Vancouver (CA)

Correspondence Address: PERLEY-ROBERTSON, HILL & MCDOUGALL LLP, 1400-340 Albert Street, OTTAWA, ON, K1R 0A5, CA

(73) Assignee: SXIP IDENTITY CORP., Vancouver, BC (CA)

(21) Appl. No.: 12/521,628

(22) PCT Filed: Jan. 11, 2008
(86) PCT No.: PCT/CA08/00040

§ 371 Date: Jun. 29, 2009

(30) Foreign Application Priority Data
Jan. 11, 2007 (US) 60884552

(51) Int. Cl. G06F 17/00

(52) U.S. Cl. 715/226; 715/221

(57) ABSTRACT

A system and method of visually indicating the availability of a form context, such as mapping, makes use of different indicator types to provide cues to a user about form mapping status. The system can determine what type of indicator to use based on a form profile, based on the availability of user profile information, or information collected by users.

### CROSS REFERENCE TO RELATED APPLICATIONS

This application claims the benefit of U.S. Provisional Application No. 60/884,552 filed Jan. 11, 2007, which is incorporated herein by reference.

### FIELD OF THE INVENTION

The present invention relates generally to electronic identity management systems. More particularly, the present invention relates to indicating the availability of a form mapping or indicating other information about a form using visual cues.

### BACKGROUND OF THE INVENTION

Internet-based identity management systems and password managing systems can often be integrated within a web-browser to provide a user with a seamless experience.

These tools rely upon the ability to obtain a mapping of fields on a webpage to data elements stored in an identity profile. User, or persona, identity information is stored in a profile, either locally or in a remote location, and is accessible to the form filling application (either an identity management tool, a password management tool, or some other form filling tool). When a form is encountered, the form-filling tool determines if there is mapping between the fields in a form and the stored elements of identity data.

Typically, form filling functionality can be provided by two different techniques. A best guess mechanism is used by some form filling applications. These applications attempt to guess the identity data that is mapped to a form field based on the name of the field. Though this provides a mapping for forms that have never been seen before, it does not offer reliability in that the guesses are not guaranteed to be accurate. Other applications make use of form mappings that map form fields to data elements stored in an identity store. These offer a much higher reliability, but a form never seen by the mapping system will not have a map in advance. Distribution of the form generation process has been employed to reduce the incidence of this problem.

The form mappings can be categorized on the basis of the type of information that a form relates to. Some forms request login information, others profile information, and still others request registration information, and can be categorized as such.

For forms that request either registration or profile information, a user can be alerted to the existence of a mapping, by prompting the user to use the form filling application to fill in information on the form. Different applications have different mechanisms for interacting with a user to allow the user to use the form filling functionality. Some form filling tools, when presented with a registration page, or a request for a portion of a profile, will colorize form fields to indicate that there is a mapping for the form. The user can then click a button, select a menu option, use a keyboard shortcut, or otherwise invoke the form filling functions of the tool. Other form filling applications provide a visual cue by overlaying the form with an interface asking whether the user would like to fill in the registration form. Still other applications ask the user to use a menu system to initiate logins or to provide profile information.

A difficulty arises when the form filling application detects a login page for which a mapping is known. Such a page will typically request that the user provide a user identifier (such as a login userid, or an email address) and a password. When a form filling application detects such a page, it may recognize the form, and have a mapping for it, but if the login information is not known, the form filling application will not be able to complete the form. New users of the form-filling application are often disappointed when they visit a login page and are not provided a cue to indicate that there is a mapping for the form, when in fact there is a mapping but the username and password are unknown. Existing users may be aware of this issue, but will still be unaware if a mapping exists for a form.

In other instances, an indication that the form is mappable is provided, and when the user chooses to use the mapping, he or she is then prompted to provide a username and password through a separate window. This results in an awkward interface for the user.

Often, a webpage can have a primary purpose, such as providing information, and still have a form field for a secondary purpose. For example, a news based site may have a field requesting a postal code so that weather information can be provided, alternatively, it may have a field that requests an email address so that updates can be sent. These fields may constitute a small portion of the page, but the visual indicator provided by the form filling application may become a nuisance or distraction to the user. As a result, many users may determine that the form filler is either an irritant, or that it degrades either performance or the web browsing experience, and accordingly be dissuaded from using the application.

It is, therefore, desirable to provide a mechanism to indicate contextual information about a form to a user when the form is not the primary intent of a page

### SUMMARY OF THE INVENTION

It is an object of the present invention to obviate or mitigate at least one disadvantage of the prior art.

In a first aspect of the present invention, there is provided a method of indicating a form mapping status. The method comprises the steps of retrieving a form mapping for a detected form having fields; determining if data elements matching mapping components are available in an identity store; determining, for each field in the form, the form mapping status in accordance with the matching of mapping components and data elements; and displaying a cue indicating the determined form mapping status for each field in the form.

In an embodiment of the first aspect of the present invention, the method further includes displaying a persona selector when the user clicks on a displayed cue, and optionally, the determined status is form mapping and data present. In another embodiment, the mapping is retrieved from a central mapping database. In a further embodiment, the step of determining the form mapping status can include determining if a form field has a corresponding mapping component. The determined form mapping status can be one of: mapping and data present which can be represented by an icon displayed at the left of the form field; mapping present without data which can be represented by an icon displayed in the form field; and mapping not present. The step of determining a form mapping status can be preceded by the step of filling form fields with the data elements available in the identity store. The determined form mapping status can be that alternate data available in identity store, which can be associated with a graphical icon displayed at the right of the field. The method can further include the step of displaying alternate values for a field retrieved from the identity store when the user clicks on the cue when the determined status is alternate data available in identity store.

In another embodiment, the step of determining the form mapping status can be performed in accordance an elapsed time since the form was displayed. The determined status can be that maximum elapsed display time expired. The method can further include the step of removing the cue.

In a second aspect of the present invention, there is provided a system for displaying a form mapping indication. The system comprises a mapping engine and a cue engine. The mapping engine receives a form and retrieves a mapping from a mapping database. The cue engine retrieves identity information from an identity store, receives the retrieved mapping and selects a cue in accordance with the retrieved identity information and the received mapping.

In an embodiment of the second aspect of the present invention, the mapping database is a centralized database accessible to the mapping engine over a network connection. In another embodiment, the cue engine includes a display interface for transmitting the determined cue to a display and a user input interface for receiving user input. The cue engine can include a decision engine for selecting the cue in accordance with user input received from the user input interface.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a login form having inline cues;

FIG. 2 illustrates an unfilled registration form with insufficient stored user data;

FIG. 3 illustrates a login form having inline cues that a mapping is present without login information;

FIG. 4 illustrates a filled registration form with cues indicating that other data elements are available for a field;

FIG. 5 is a flowchart illustrating a method of the present invention; and

FIG. 6 is a block diagram illustrating functional components of an embodiment of the present invention.

### DETAILED DESCRIPTION

Generally, the present invention provides a method and system for displaying an indication about the context of a field in a form.

Reference is made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

The present invention addresses the fact that most form filling tools make use of a binary indication system. Either a form can or cannot be filled in. This does not address a number of situations that often arise. Often form mappings are available, but the data is not known (often occurs with login forms), other times, there are multiple valid data elements that could be provided in the field. In the example of a registration form, there may be a number of different values that can be provided to a field, such as username or password.

To address these issues, the present invention makes use of a system and method for providing the user with visual cues that provide the user context about a form mapping status. If no cues are provided, it is likely that a form has no mapping, however, if a mapping is present, the user can determine, at a glance, whether or not data for the form is available.

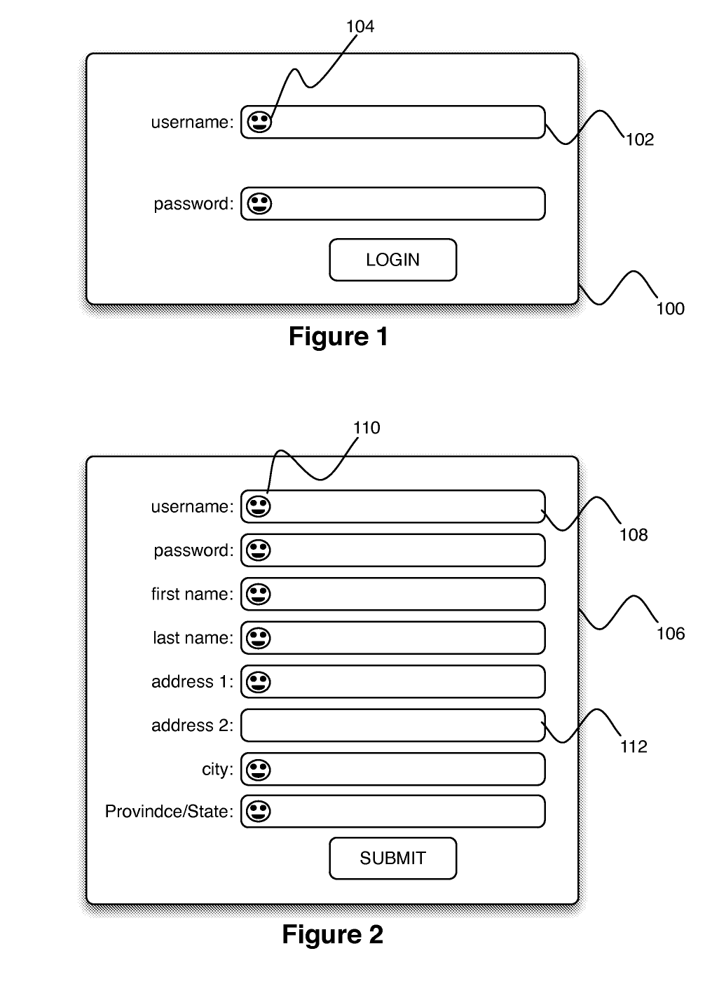

FIG. 1 illustrates a portion of a form that is used for a login. Instead of providing an overlay indicating the presence of the login mapping, the present invention displays a visual cue indicating the availability of a mapping. The cue is preferably provided in the form field, but it is possible to provide a cue outside the form field without departing from the scope of the present invention. In FIG. 1, a login form 100 is presented. The form has fields 102 that request the username and password. A visual cue 104 is provided in the fields indicating that a mapping is present, and that the identity store includes information that can be mapped to these form fields. In this case, it would indicate that the form mapping and login information to the site are known. The user can activate the form filling application by clicking on the icons (or in the fields). In some embodiments, a login selector is activated (if there is more than one known login), while in other instances, the login information is fed into the form automatically upon activation of the form filling application. Those skilled in the art will appreciate that the manner in which the form filling application provides the data to the form is not necessarily within the scope of the present invention and a number of different techniques can be used without departing from the scope of the present invention. Activation of the form filling functionality can also be performed by a secondary action on the form fields, such as a right mouse click. One skilled in the art will appreciate that reference to a right-click indicates the use of a pointer such as a mouse and the use of a secondary button. This should not be construed as limiting, other actions, such as left-click on icon, double-clicking, or using key strokes, menu options or other equivalent functional steps that will be well understood and known to those skilled in the art.

The use of a graphical element provides a clear indication that a certain form context is known and/or available. The system of the present invention can provide overlays for some forms, and provide graphical inserts for other forms. A form filler can make use of both overlaid mapping indicators and in-line indicators based on information in the mapping itself, a user preference, or a decision made in conjunction with both the user preference and the mapping.

FIG. 2 illustrates a registration form using the in-line indicators to indicate a form mapping. If the user is presented with an overlay for a registration form, and requests that the overlay be cancelled, the in-line indicators can be used to still remind the user that the form is mapped. This provides the user with a multi-level mapping indicator. The first time that a user visits the form, an overlay, such as a translucent overlay can be displayed over a form, if the user cancels the overlay, or indicates that the overlay is to never be displayed for that form again, the in-line indication can be provided. This provides a different user experience than can be obtained by systems that simply provide one type of mapping indication.

FIG. 2 illustrates a registration form 106. As before, the form has fields such as field 108 that includes indicator 110, but also includes fields such as field 112 that does not have an indicator. This lack of mapping availability cue can indicate that there is a mapping for the form, but there is no identity data in the identity data store that is mappable to the values requested in field 112. In an alternate embodiment, the lack of an indicator in field 112 may indicate that the field is not mapped, while the other fields are. One skilled in the art will appreciate that in other embodiments, the lack of an in-line indicator can mean either of the above, as the end result is that the form filling application will not be able to insert data values into that field (either due to not have access to the relevant data, or not having a mapping for that field).

One problem often encountered by users of form filling applications is that when a user visits a login form that has a mapping but the data required for a mapping is not known, providing an indication that a mapping exists, is difficult. If the username and password are not stored in the identity store, providing an overlay, or showing the same indicator used to indicate that the form is mapped and the data is known, can cause user confusion or inconvenience. If the form filler provides an overlay, or another indication that the form is mapped, the user can click to fill in the form, and then be confronted by an interface requesting a username and password. Although this is functionally sufficient, it is a poor experience for the user, who would have been better off simply being able to type the username and password into the form.

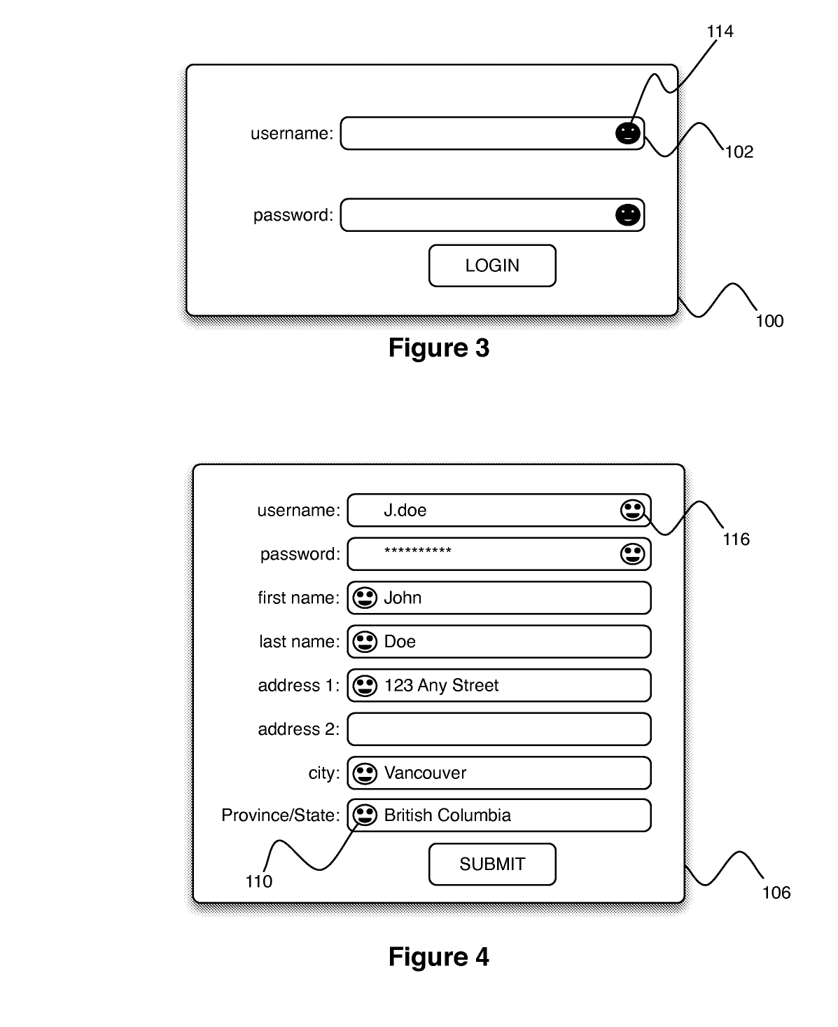

FIG. 3 illustrates an embodiment of the present invention, where a modified in-line graphical element is used as a visual cue to indicate to the user that a mapping exists for the form, but the data is not known. The same login form 100 as shown in FIG. 1 is illustrated. Here the username and password values are not available to the form filling application. As such the fields, such as field 102, display an alternate mapping status indicator 114. In the illustrated embodiment, the indicator 114 is similar to the indicator used in previous figures, but the coloration of the indicator is changed to indicate that the mapping is known, but the data for the mapping is unknown. By entering the username and password into the form, and performing a login, the user is able to supply the form-filler application with the required data. This provides the user an enhanced use experience.

One skilled in the art will appreciate that by introducing a multiple level indication system, the present invention provides a number of indications to the user that form filling functionality, or another identity transaction, is available. The selection of the indication, be it a high level indication such as an overlay, or a lower level indicator such as an inline graphic, that can then be greyed out or otherwise modified, can be performed on the basis of the broad class of form detected, particular information about the form (such as information associated with the URL where the data of the form is sent to) or in accordance with the form and a user preference, or the state of the user's profile.

In another embodiment, the multi-level indicator system can be expanded to include different indicators to indicate different mapping status messages to users. For example, on a form that has been mapped by a user, but the mapping has not yet been either widely used or has not been approved, a unique identifier could be used alerting the user to the fact that the mapping is not yet fully approved. In a system that uses both inline graphical indicators and translucent overlays, this indicator could take the form of either a different inline icon or a differently presented overlay (including a different colorization of either the icon or the overlay). The system can select between using different levels of indicators based on the same guidelines described above.

In a system that relies upon a distributed user base to contribute form mappings, but only has a single indicator level, the request to provide a mapping of the form, can be large and unwieldy for a small form. Accordingly, a lower level indicator, such as an inline graphic as described and illustrated above, can be used to indicate that a form mapping is requested. If there are fields in the form for which a best guess can be provided to assist in the mapping, the fields for which a best guess is available can be indicated as such to encourage the user to create the mapping.

In-line indication, such as the graphical icons illustrated in FIGS. 1-3, or other indicators such as changing the color of a field in a form can be used for a number of other uses under the present invention. For example a visual cue can be provided to indicate a suspicion of phishing activity (either through reputation, user reporting, or a determination based on the destination for the data collected on the form). Other visual cues can be used to inform the user that a machine-readable privacy policy includes terms that the user has not previously accepted, or that the privacy policy is not as rigorous as the user usually prefers.

In another embodiment, an inline indicator or other visual cue can be used on a registration form to indicate that although a login to a particular site is not known, an associated registration form has been mapped. Upon activating functionality associated with this indication, the user can engage the identity management application generating the indicator to create a login using the associated registration form.

The in-line indicators can also be used to indicate a reputation associated with the website that the form data is being transmitted to. It is possible, both through analysis of traffic to assigned email addresses, and through user feedback, to determine if a site provides submitted email addresses for use with unsolicited commercial email (UCE), also referred to as spam. Reputations for how the user information is used, such as the propensity of a site to provide addresses for UCE, can be reflected using the visual cues, including the use of an icon indicating that the requested email address may not be kept secure.

When a site requests updated profile data after the initial registration, visual cues can be used to remind the user that the requested data has previously been provided to the site by the user. It is also envisioned that if the user clicks on a graphical icon used to provide this indication, that the form filler can display the information that was previously provided.

Often, when a user completes a form using a form filling application, there are multiple values that could be provided for a given field. In one example, illustrated in FIG. 4, the registration form 106 of FIG. 2 is shown after the data has been filled in. Fields such as the username and password may have a number of different values that can be used. As such, instead of the standard indicator 110, an indicator can be either altered or put in a different location such as indicator 116, which is displayed at the right side of the field, instead of the left side. This can serve as an indication that alternate values for the field are available in the identity store. By clicking on the indicator 116, the user can activate a pick list that provides alternate values. For fields such as a password, the indicator can be further altered to tell the user information about the value put in the form. Many form fillers make use of random password generators for logins. Though this makes the login more secure, it is often difficult for a user that uses a number of different systems and may not always have access to the identity store in which the random password is stored. As such, a plurality of passwords can be stored, and when the indicator can be modified to show which password is used. The modification can be a text character, or other small indicator, showing which password is used. When the user activates the pick list by clicking on the indicator, the user can be provided with a pick list of passwords, but instead of being shown the password, the user can be shown a hint associated with the password. This provides a further layer of security to ensure that no one can simply obtain the user's passwords by attempting to fill out a registration form.

As noted above, though the illustrated examples make use of a graphical icon as the cue indicating the mapping status, other indicators can be used. Coloration of the form fields can be used to show different statuses.

In some situations, the indicators can be hidden from the user. If a user loads a page that has a form, but makes no attempt to activate the form filler within a defined elapsed time limit, the indicators can be hidden or modified. This can be done to remove clutter from the screen. The indicators can be revealed to the user if certain actions are taken, such clicking in the form, or possibly even placing a pointer, such as a mouse, over a field in the form.

Whereas prior art form filling applications have made use of a binary indication system, the present invention makes use of a richer interface to provide more information to the user at a glance. This can be used to provide security information, general information, or it can be used to simply enhance the user experience. Those skilled in the art will appreciate that the examples of reasons for using the multi-level indication system outlined above are not intended to be exhaustive and are instead merely exemplary.

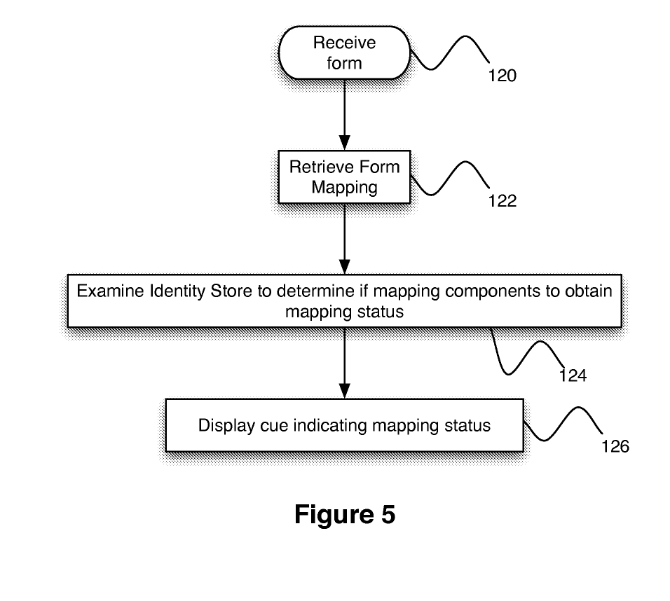

FIG. 5 is a flowchart illustrating a method of the present invention. In step 120, the form is received. This is conventionally done through a web browser, where a plugin providing the form filling functionality intercepts the form. The form mapping is then retrieved in step 122. This commonly requires that a mapping database is queried for the form mapping. The mapping database can be local to the user's system, or it can be accessed through a data networking connection. It should be noted that the form mapping can be a null value, indicating that the form has no available mapping. The term form mapping need not be narrowly construed to mean that a mapping of each field in the form is available. Some, all, or even none of the form fields can be mapped to data elements (or data element types) in the identity store.

In step 124, the data elements of the identity store are examined to determine if the components of the mapping have matches in the identity store. In accordance with the results of step 122 and 124, a mapping status can be determined. Examples of the mapping status are: form mapping not available; mapping available but no data is available; mapping and data are available; mapping is available as is alternate data; form data is redirected to an untrustworthy source (possible collection point for UCE or phishing). Other status types will be understood by those skilled in the art. In step 126 a cue indicating the determined mapping status is displayed.

It should be noted that the mapping status can be applied in varying degrees of granularity. A mapping status can be applied to an entire form, portions of a form can have different mapping statuses, or each field in the form can be provided with its own mapping status. The displayed cue preferably is provided with the same granularity as the determined mapping status. After displaying the cue, the form filling application can provide the user with the ability to fill data into the form as appropriate.

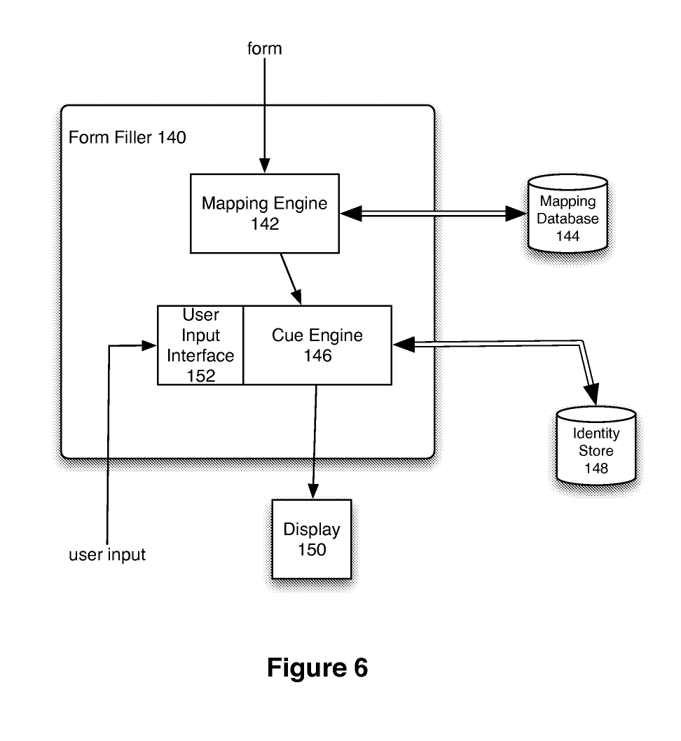

FIG. 6 is a block diagram illustrating an exemplary embodiment of the present invention. Form filler 140 includes the elements needed to retrieve the data from the identity store and to fill the form in, and provide the data back to the browser. These elements are not core the present invention, and as such are not illustrated as one skilled in the art will already understand the functional elements required for the conventional operation of a form filler. Form filler 140 receives a form, typically through a browser (not shown). Form filler 140 can be implemented in any number of different ways, including as a plugin to the unillustrated browser, as a standalone application, as an integrated component to a browser, or as an element of an operating system. The form is provided to mapping engine 142. Mapping engine 142 issues a mapping request to mapping database 144. Database 144 can be local to the same system as the form filler 140 or it can be remotely accessed through a data network such as the Internet. Form mappings are requested over a data connection and are received in response. As noted above, the lack of a mapping can be considered to be a trivial result indicating a null mapping. The mapping is provided to cue engine 146, which determines a mapping status in accordance with the mapping provided by mapping engine 142 and the data elements available in identity store 146. The components of the mapping, which relate the fields in the form to data element types, and the types of data elements available in the identity store are used to determine the mapping status. The mapping status can relate solely to the availability of a mapping and the corresponding data, it can relate to information contained in the mapping such as an indication of a likely phishing attempt, it can relate to the availability of guesses for an unmapped for, or other status information that is desirable to convey to a user.

In accordance with the determined mapping status, the cue engine 146 selects cues to associate with the form and sends them to display 150. Display 150 is typically provided by the browser, which renders the cues as modifications to the received form. These modifications provide a cue, typically a visual cue, to the user indicating the status of a form, or of form elements. Non visual cues, such as audio cues, can be provided in alternate embodiments such as those intended for use by visually impaired users.

A user input interface 152 can be provided to allow user input, such as instructions to dismiss a cue, or other such actions to change the cues selected by cue engine 146. User input can also be considered to be a lack of attention to a form on a webpage, resulting the cue engine 146 removing the cues displayed on the form. When a user invokes the form filler 140 to fill a form, such as a profile request, with data elements from the identity store, cue engine 146 can alter the cues to reflect a new mapping status, such as the availability of alternate data as described above.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of indicating a form mapping status comprising:
retrieving a form mapping for a detected form having fields;
determining if data elements matching mapping components are available in an identity store;
determining, for each field in the form, the form mapping status in accordance with the determined matching of mapping components and data elements; and
displaying a cue indicating the determined form mapping status for each field in the form.

2. The method of claim 1 further including displaying a persona selector when the user clicks on a displayed cue.

3. The method of claim 2 wherein the determined status is form mapping and data present.

4. The method of claim 1 wherein the mapping is retrieved from a central mapping database.

5. The method of claim 1 wherein the step of determining the form mapping status includes determining if a form field has a corresponding mapping component.

6. The method of claim 5 wherein the determined form mapping status is one of: mapping and data present, mapping present without data and mapping not present.

7. The method of claim 6 wherein the determined status is mapping and data present and the cue includes an icon displayed at the left of the form field.

8. The method of claim 6 wherein the determined status is mapping present without data and the cue includes a greyed out icon in the form field.

9. The method of claim 1 wherein the step of determining a form mapping status is preceded by the step of filling form fields with the data elements available in the identity store.

10. The method of claim 9 wherein the determined form mapping status is alternate data available in identity store.

11. The method of claim 10 wherein the cue includes a graphical icon displayed at the right of the field.

12. The method of claim 10 further including the step of displaying alternate values for a field retrieved from the identity store when the user clicks on the cue when the determined status is alternate data available in identity store.

13. The method of claim 1 wherein the step of determining the form mapping status is performed in accordance an elapsed time since the form was displayed.

14. The method of claim 13 wherein the determined status is maximum elapsed display time expired.

15. The method of claim 14 further including the step of removing the cue when the determined status is maximum elapsed display time expired.

16. A system for displaying a form mapping indication comprising:
a mapping engine for receiving a form and retrieving a mapping from a mapping database; and
a cue engine for retrieving identity information from an identity store, for receiving the retrieved mapping and for selecting a cue in accordance with the retrieved identity information and the received mapping.

17. The system of claim 16 wherein the mapping database is a centralized database accessible to the mapping engine over a network connection.

18. The system of claim 16 wherein the cue engine includes a display interface for transmitting the determined cue to a display.

19. The system of claim 16 wherein the cue engine includes a user input interface for receiving user input.

20. The system of claim 19 wherein the cue engine includes a decision engine for selecting the cue in accordance with user input received from the user input interface.
